(19) United States
(12) Patent Application Publication
(10) Pub. No.: US 2012/0078546 A1
(43) Pub. Date: Mar. 29, 2012

(54) LOAD-SIDE VOLTAGE DETECTION VIA ELECTRIC METERING PROCESSING

(75) Inventors: Marjorie Jo Mancuso, Center Tuftonboro, NH (US); John Paul Junker, Wentzville, MO (US); Gregory Paul Lavoie, Barrington, NH (US); Robert Edward Lee, JR., Dover, NH (US)

(73) Assignees: MAXIM INTEGRATED PRODUCTS, INC., Sunnyvale, CA (US); GENERAL ELECTRIC COMPANY, Schenectady, NY (US)

(21) Appl. No.: 12/892,005

(22) Filed: Sep. 28, 2010

(51) Int. Cl. G06F 19/00

(52) U.S. Cl. 702/61

(57) ABSTRACT

Load-side voltage detection via electric metering processing is disclosed. In one aspect, load-side voltage is provided as an input to a metering processing unit. The metering processing unit determines a voltage level of the load-side voltage. An application processing unit uses the voltage level to control operation of a service disconnect relay.

### BACKGROUND OF THE INVENTION

The present invention relates generally to electric meters and more particularly to load-side voltage detection via electric metering processing.

Electric meters are typically implemented with disconnect switches that allow the meters to remain installed upon activation, but remove electrical service from customers that are attached to the meters. Typically, a disconnect switch is implemented under the cover of the electric meter. Putting the disconnect switch under the cover of the electric meter with a two-way communication device enables remote activation of the switch, so that the electric service can be reconnected and disconnected. This obviates the need to send a meter technician out to the location of the customer to disconnect the electric service. When restoring the electric service to the customer via the disconnect switch, a technician needs to ascertain whether there is a voltage that is currently being supplied. Closing the disconnect switch into a load-side voltage can be potentially dangerous. For instance, closing the disconnect switch in the presence of a load-side voltage could seriously damage electrical equipment (e.g., a generator) that may be in use at the site of the customer. Typically, load-side voltage detection is performed by using extra circuitry that is implemented within the electric meter. This extra circuitry that is implemented within the electric meter is expensive, difficult to implement with other components associated with the electric meter, and oftentimes unreliable in detecting the presence or absence of a load-side voltage.

### BRIEF DESCRIPTION OF THE INVENTION

In one aspect of the present invention, a utility metering device is provided. The utility metering device comprises a load-side voltage detection circuit that detects load-side voltage. A metering processing unit receives the load-side voltage from the load-side voltage detection circuit and measures the voltage level of the detected load-side voltage. An application processing unit receives the measured voltage level from the metering processing unit and determines the presence of the load-side voltage from the measured voltage level.

In another aspect of the present invention, an energy meter is provided. In this aspect of the present invention, the energy meter comprises a service disconnect relay. A load-side voltage detection circuit is configured to detect load-side voltage. A metering processing unit is configured to receive the load-side voltage as an input from the load-side voltage detection circuit and measure magnitude of the detected load-side voltage. An application processing unit is configured to receive the measured magnitude of the detected load-side voltage from the metering processing unit and control operation of the service disconnect relay as a function of the measured magnitude.

In a third aspect of the present invention, a method for restoring an electric service is disclosed. In this aspect of the present invention, the method comprises: detecting a load-side voltage; inputting the load-side voltage to a metering processing unit; measuring magnitude of the load-side voltage; determining the presence of the load-side voltage as a function of the measured magnitude; and restoring the electric service in response to determining that the measured magnitude is indicative of the absence of load-side voltage.

### BRIEF DESCRIPTION OF THE DRAWINGS

FIG. 1 is a schematic diagram illustrating an overview of an electric meter in use with a utility provider and a utility consumer;

FIG. 2 is a schematic block diagram of an electric meter configured to detect load-side voltage using electric metering processing according to one embodiment of the present invention; and

FIG. 3 shows a flow chart illustrating the operation of restoring an electric service using the electric meter depicted in FIG. 2 according to one embodiment of the present invention.

### DETAILED DESCRIPTION OF THE INVENTION

Various embodiments of the present invention are directed to inputting load-side voltage into a metering processing unit to facilitate the process of determining whether or not to activate a service disconnect switch (e.g., a service disconnect relay) that is implemented with an electric meter. In one embodiment, a load-side voltage detection circuit provides load-side voltage to the metering processing unit. The meter processing unit determines the voltage level by measuring the magnitude of the voltage. An application processing unit receives the voltage level of the load-side voltage and determines whether the service disconnect relay should be activated. In particular, if the application processing unit determines that the voltage level is indicative of a presence of a load-side voltage, then the application processing unit keeps the service disconnect relay opened to prevent reconnection of the electric service. On the other hand, if the application processing unit determines that the voltage level is indicative of an absence or lack of a load-side voltage, then the application processing unit directs the closing of the disconnect switch to permit connection of the electric service. In another embodiment, a phase voltage circuit provides line-side voltage to the metering processing unit. In this embodiment, the metering processing unit uses the load-side voltage and the line-side voltage to facilitate a determination of the phase relationship between these voltages. The application processing unit uses the phase relationship between line-side voltage and the load-side voltage to determine if the electric service to a customer (e.g., a residence or business) has been altered. Technical effects of the various embodiments of the present invention include eliminating the need for additional circuitry which is expensive and unreliable in detecting for the presence of a load-side voltage. Other technical effects associated with the various embodiments of the present invention include the ability to detect whether electrical service to a customer has been tampered or altered.

Although various embodiments of the present invention are described with respect to use with an electric meter and electric utility service, the embodiments are not limited to use solely with these items. Those skilled in the art will recognize that the various embodiments of the present invention are suitable for use with other metering devices and utility services. A non-exhaustive list of other metering devices where the various embodiments of the present invention are suitable for use include gas, water and heat meters. Similarly, a non-exhaustive list of other utility services where the various embodiments of the present invention are suitable for use include gas, water and heat services.

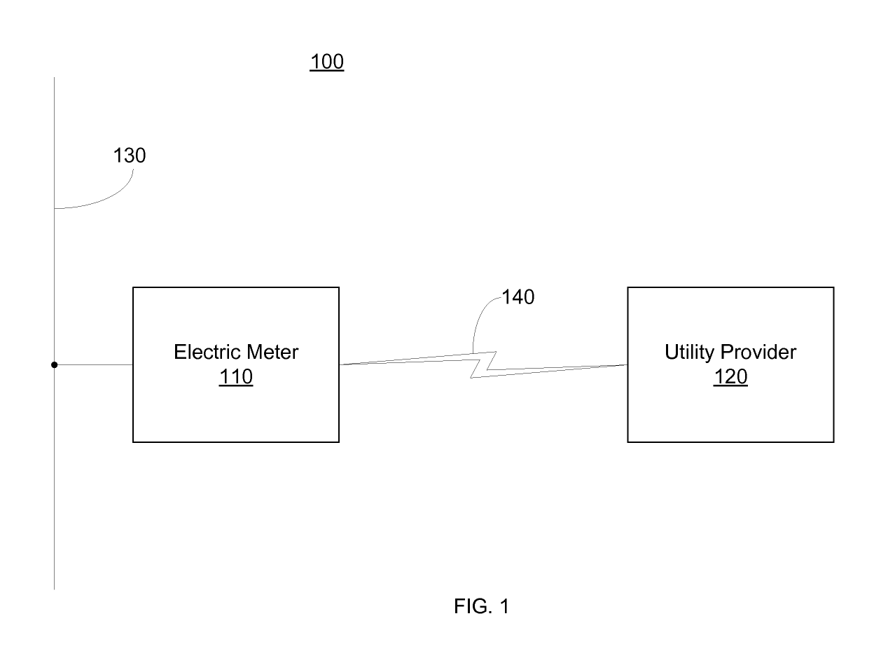

Referring to the drawings, FIG. 1 is a schematic diagram illustrating an overview 100 of an electric meter 110 in use with a utility provider 120 and a consumer utility line 130. As shown in FIG. 1, electric meter 110 is provided to consumer utility line 130 from which an electric service (e.g., electricity) is received from utility provider 120. Electric meter 110 may monitor and store electricity usage and/or demand information for consumer utility line 130. Electric meter 110 may further monitor and record status information for consumer utility line 130. Utility provider 120 may interact with electric meter 110 through a signal path 140. A variety of methods, both wired and wireless, may be utilized for signal path 140. For example, electric meter 110 may communicate through a telephone line, an automatic meter reading system, an optical port, a Recommended Standard (RS)-232 line, wireless systems, or through other means of communications. In addition, receiving devices, such as hand-held devices, may communicate with electric meter 110. These receiving devices may subsequently communicate any collected information to utility provider 120. Examples of receiving devices may include cellular devices such as phones, personal digital assistants (PDAs), notebook computers, specialized receivers, or handheld devices. The receiving devices or aspects thereof may also be incorporated with mobile vehicles, including those utilized with automatic meter reading systems. These types of receiving devices may be utilized by personnel visiting one or more electric meters 110.

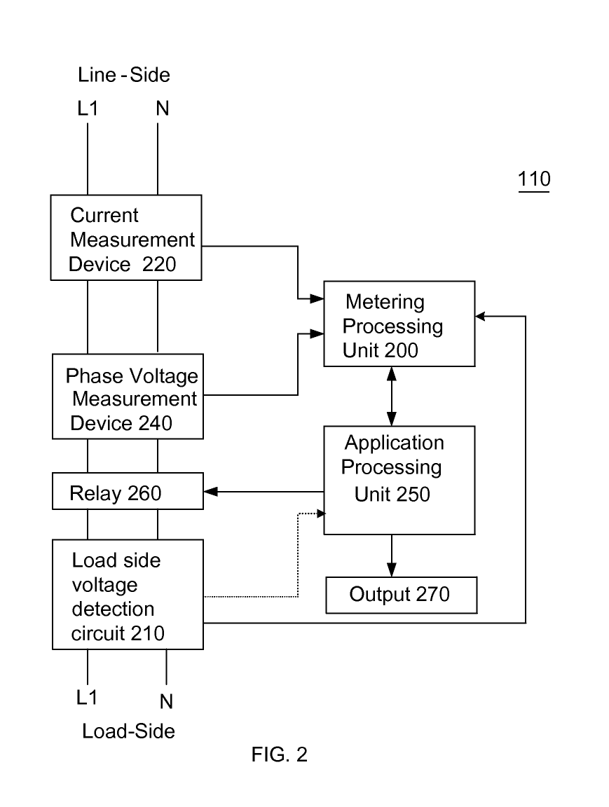

As described herein, one function performed by electric meter 110 is to facilitate closing of a service disconnect relay in order to reconnect the electric service from utility provider 120 to a consumer via consumer utility line 130. FIG. 2 is a schematic block diagram illustrating some of the components in electric meter 110 that facilitate this function according to one embodiment of the present invention. As shown in FIG. 2, electric meter 110 includes a metering processing unit 200 that receives input data generated from a load-side voltage detection circuit 210, a current measurement device 220, and a phase voltage measurement device 240. Metering processing unit 200 performs certain processing operations on this input data as explained below and forwards the processed data to an application processing unit 250. Metering processing unit 200 may be any commercially available metering processing device such as a system on a chip (SOC) metering chip. One example of a commercially available SOC metering chip that may be used as metering processing unit 200 is a Teridian 71M6521 power meter integrated circuit sold by Teridian Semiconductor. Those skilled in the art will recognize that there are other commercially available power meter integrated circuits that may be used.

As described below, application processing unit 250 determines the presence or absence of a load-side voltage between the load side terminals (L1 wire and neutral N). If application processing unit 250 determines that there is a presence of a load-side voltage, then the application processing unit keeps a service disconnect relay 260 open, so that electricity is not reconnected from the utility provider 120 (FIG. 1) to the consumer utility line 130 (FIG. 1). If the application processing unit 250 determines that there is an absence or lack of a load-side voltage, then the application processing unit directs service disconnect relay 260 to close so that electricity is reconnected from the utility provider 120 (FIG. 1) to the consumer utility line 130 (FIG. 1). In another embodiment, as described below, metering processing unit 200 determines the phase relationship between the load-side voltage and the line-side voltage between the line side terminals (L1 wire and neutral N), so that application processing unit 250 can determine if the electric service from the utility provider 120 (FIG. 1) to consumer utility line 130 (FIG. 1) has been altered. Application processing unit 250 may be any commercially available application processing device used for metering purposes. One example of a commercially available application processing device that may be used for metering purposes is a NEC uPD70F3729 application processing unit sold by NEC Corporation. Those skilled in the art will recognize that there are other commercially available application processing units that may be used.

Referring back to FIG. 2, load-side voltage detection circuit 210 detects load-side voltage. As used herein, load-side voltage is any voltage present between the load side terminals of electric meter 110 (FIG. 1). In one embodiment, load-side voltage detection circuit 210 may be a voltage sensor (e.g., a resistive divider) that detects load-side voltage. An output representative of the measured signal is supplied from load-side voltage detection circuit 210 as an input to metering processing unit 200.

As mentioned above, additional inputs supplied into metering processing unit 200 includes current signals generated from current measurement device 220 and a line-side voltage from phase voltage measurement device 240. In one embodiment, current measurement device 220 may be a current transformer, however, those skilled in the art will recognize that other current measurement devices may be used such as for example, a shunt and a Rogowski coil. In one embodiment, phase voltage measurement device 240 may be a voltage divider that detects that detects line-side voltage. As used herein, line-side voltage is any voltage present between the line side terminals of electric meter 110 (FIG. 1). Outputs representative of the measured signals from current measurement device 220 and phase voltage measurement device 240 are inputted to metering processing unit 200 for various processing before being sent to applications processing unit 250.

One of the processing functions performed by metering processing unit 200 includes ascertaining the voltage level of the load-side voltage inputted from load-side voltage detection circuit 210. In one embodiment, metering processing unit 200 determines the voltage level of the load-side voltage by determining the magnitude of this signal sent from load-side voltage detection circuit 210. The magnitude of the load-side voltage is sent from the metering processing unit 200 to the application processing unit 250, which determines the presence of the load-side voltage from the measured voltage level. If application processing unit 250 determines that the magnitude of the measured voltage level is indicative of a presence of a load-side voltage, then application processing unit keeps service disconnect relay 260 open in an open state. On the other hand, if application processing unit 250 determines that the magnitude of the voltage level is indicative of an absence or lack of a load-side voltage, then the application processing unit directs the closing of service disconnect relay 260 to a closing state so that electric service is reconnected. In one embodiment, a voltage level magnitude greater than a threshold (e.g., 10V) would be an indication of the presence of a load-side voltage, while a value below the threshold (e.g., 10V) would be an indication that there is an absence or lack of load-side voltage.

Another processing function performed by metering processing unit 200 includes facilitating a determination of a phase relationship between the load-side voltage provided by load-side voltage detection circuit 210 and the line-side voltage provided by phase voltage circuit 240. In one embodiment, metering processing 200 calculates a voltage quantity from which application processing unit 250 can determine the phase relationship by performing the following calculation:

V_{line-load}²h=Σₖ₌₁^{N}(Vₗᵢₙₑ−V_{load})², where

Vₗᵢₙₑ and V_{load} are line and load-side voltage samples respectively, N is the number of samples in a momentary interval, h is hours and k is the index for the summation.

The phase relationship is determined by application processing unit 250 in the following manner. If there is a load-side voltage present and V²_{line-load}h is above a first predefined threshold, then the line and load side voltages are out of phase. If a load-side voltage is present and V²_{line-load}h is below a second predefined threshold (the first and second predefined thresholds can have the same threshold and can also have a different threshold values), then the line and load side voltages are in phase. With this method, one can determine if the line and load side voltages are approximately 180 degrees out of phase, which can also indicate tampering. In one embodiment, application processing unit 250 can determine that the cause of the load-side voltage is an alternate source, such as for example, a customer's generator, or is the result of possible tampering by bypassing the switch based on this phase relationship. Based on this determination, a notification may be sent to a meter technician for follow-up with the customer via an output 270. In one embodiment, output 270 can generate a notification such as an email communication to the meter technician. In another embodiment, output 270 may generate a display having a message obtained from memory that indicates the possibility of tampering. In another embodiment, output 270 may generate an alert to other systems (e.g., an AMI card) coupled to electric meter 110 that indicate the possibility of tampering.

Those skilled in the art will recognize that electric meter 110 can perform more functions than those previously described herein. For instance, electric meter 110 can determine the total usage of the electric service by a consumer, the rate of usage of the service, the amount of electricity provided in watts. These are only a small listing of usage statistics that may be computed by electric meter 110. Other well-known statistics are within the scope of the various embodiments of the present invention.

For the sake of simplicity in illustrating various embodiments of the present invention, those skilled in the art will recognize that not all features and functionalities associated with electric meter 110 are illustrated in FIG. 2. For example, those skilled in the art will appreciate that electric meter 110 can have other relays than what is shown in FIG. 2. In addition, electric meter 110 can be configured to measure different electrical services. In addition, electric meter 110 may have an LCD or other means to display various parameters. Electric meter 110 could also have additional detection circuits to detect different conditions such as if there is sufficient power being supplied to metering processing unit 200 or application processing unit 250. Other components that electric meter 110 may include are memory for storing data and instructions, communication interfaces, a power supply and various switches.

Note that the processing functions described above (i.e., load-side voltage detection and electric service tampering) may be invoked upon a determination that there is a desire to continue supplying the electric service to a customer after some form of suspension in service. Before a technician can initiate the supply of the electric service to the customer, a determination has to be made that there is no load-side voltage present. In response to this desire to continue supplying the electric service to the customer, application processing unit 250 requests that metering processing unit 200 forward the voltage level of the signal provided by load-side voltage detection circuit 210.

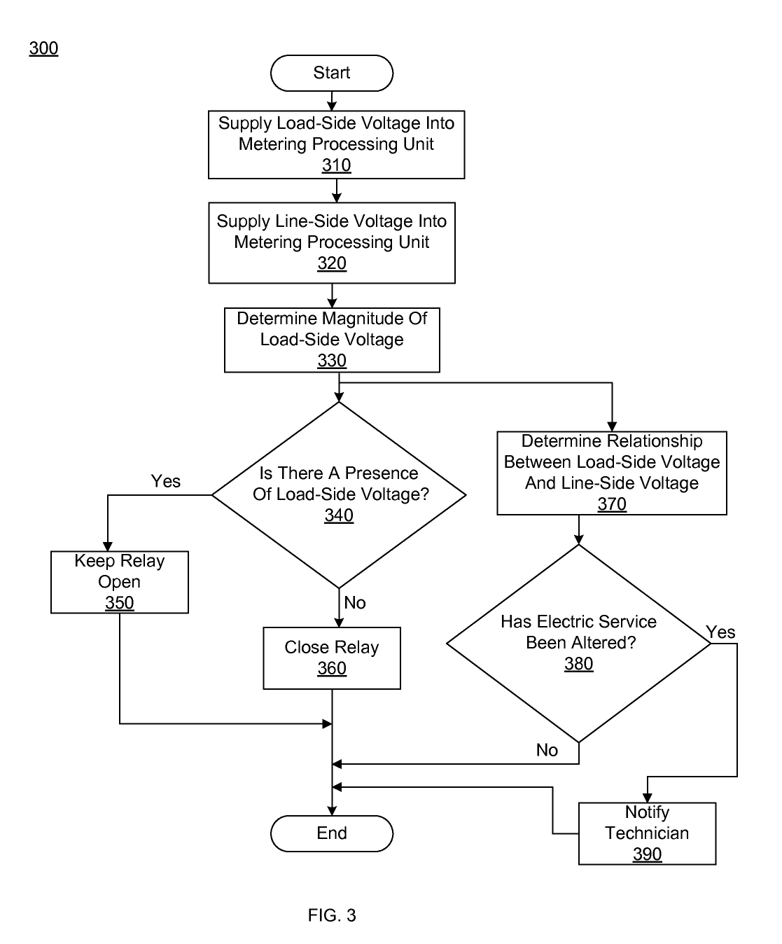

FIG. 3 shows a flow chart 300 according to one embodiment of the present invention that illustrates the operation of restoring an electric service using the electric meter depicted in FIG. 2 upon receiving a request to restore service. Flow chart 300 of FIG. 3 begins by supplying the load-side voltage from load-side voltage detection circuit 210 (FIG. 2) to metering processing unit 200 (FIG. 2) at 310 and supplying the line-side voltage from phase voltage measurement device 240 (FIG. 2) to metering processing unit 200 (FIG. 2). In one embodiment, metering processing unit 200 (FIG. 2) determines the magnitude of the voltage level of the load-side voltage at 330.

The magnitude of the load-side voltage is sent from the metering processing unit 200 (FIG. 2) to the application processing unit 250 (FIG. 2), which determines the presence of the load-side voltage from the measured voltage level. Referring again to FIG. 3, if application processing unit 250 (FIG. 2) determines at 340 that the magnitude of the measured voltage level is indicative of a presence of a load-side voltage, then application processing unit keeps service disconnect relay 260 (FIG. 2) in an open state at 350. On the other hand, if application processing unit 250 (FIG. 2) determines at 340 that the magnitude of the voltage level is indicative of an absence or lack of a load-side voltage, then the application processing unit directs the closing of service disconnect relay 260 (FIG. 2) to a closing state at 360. As mentioned above, in one embodiment, a voltage level magnitude greater than a specified threshold would be an indication of the presence of a load-side voltage, while a value below a specified threshold would be an indication that there is an absence or lack of load-side voltage.

In another embodiment, electric meter 110 (FIG. 2) may also determine during the operation of restoring an electric service whether the electric service has been altered or tampered with. Referring again to FIG. 3, metering processing unit 200 (FIG. 2) facilitates a determination of the phase relationship between the load-side voltage and the line-side voltage at 370. The actual phase relationship is determined by the application processing unit 250 (FIG. 2). In addition, application processing unit 250 (FIG. 2) determines if the electric service from utility provider 120 (FIG. 1) to consumer utility line 130 (FIG. 1) has been altered or tampered with at 380. If application processing unit 250 (FIG. 2) determines that the electric service has been altered at 380, then a notification may be sent to a meter technician for follow-up with the customer at 390. On the other hand, if application processing unit 250 (FIG. 2) determines that the electric service has not been altered at 380, then application processing unit will not notify the meter technician about possible service tampering.

The foregoing flow chart of FIG. 3 shows some of the processing functions associated with restoring electric service using electric meter 110 depicted in FIG. 2. In this regard, each block represents a process act associated with performing these functions. It should also be noted that in some alternative implementations, the acts noted in the blocks may occur out of the order noted in the figure or, for example, may in fact be executed substantially concurrently or in the reverse order, depending upon the act involved. Also, one of ordinary skill in the art will recognize that additional blocks that describe the processing functions may be added.

In various embodiments of the present invention, electric meter 110 can be implemented in the form of an entirely hardware embodiment, an entirely software embodiment or an embodiment containing both hardware and software elements. In one embodiment, the processing functions performed by electric meter 110 may be implemented in software, which includes but is not limited to firmware, resident software, microcode, etc.

Furthermore, the processing functions performed by electric meter 110 can take the form of a computer program product accessible from a computer-usable or computer-readable medium providing program code for use by or in connection with a computer or any instruction execution system (e.g., processing units). For the purposes of this description, a computer-usable or computer readable medium can be any computer readable storage medium that can contain or store the program for use by or in connection with the computer, instruction execution system, apparatus, or device or a computer readable transmission medium that can communicate, propagate or transport the program for use by or in connection with the computer, instruction execution system, apparatus, or device.

The computer readable medium can be an electronic, magnetic, optical, electromagnetic, infrared, or semiconductor system (or apparatus or device) or a propagation medium. Examples of a computer-readable medium include a semiconductor or solid state memory, a random access memory (RAM), a read-only memory (ROM), a rigid magnetic disk and an optical disk. Current examples of optical disks include a compact disk—read only memory (CD-ROM), a compact disk—read/write (CD-R/W) and a digital video disc (DVD).

While the disclosure has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the disclosure.

What is claimed is:

1. A utility metering device, comprising:
a load-side voltage detection circuit that detects load-side voltage;
a metering processing unit that receives the load-side voltage from the load-side voltage detection circuit and measures the voltage level of the detected load-side voltage; and
an application processing unit that receives the measured voltage level from the metering processing unit and determines the presence of the load-side voltage from the measured voltage level.

2. The utility metering device according to claim 1, further comprising a service disconnect relay controlled by operational commands provided from the application processing unit.

3. The utility metering device according to claim 2, wherein the application processing unit directs the service disconnect relay to remain in an open state in response to determining the presence of load-side voltage and directs the service disconnect relay to a closed state in response to determining the absence of load-side voltage.

4. The utility metering device according to claim 1, further comprising a phase voltage measurement device that detects line-side voltage.

5. The utility metering device according to claim 4, wherein the metering processing unit is further configured to receive the line-side voltage from the phase voltage measurement device for facilitating a determination of a phase relationship between the line-side voltage and the load-side voltage provided by the load-side detection circuit.

6. The utility metering device according to claim 5, wherein the metering processing unit calculates a voltage quantity defined as: V_{line-load}²h=Σₖ₌₁^{N}(Vₗᵢₙₑ−V_{load})², where Vₗᵢₙₑ and V_{load} are line and load-side voltage samples, respectively, N is the number of samples in a momentary interval, h is hours and k is the index for the summation.

7. The utility metering device according to claim 6, wherein the application processing unit determines the phase relationship between the line-side voltage and the load-side voltage provided by the load-side detection circuit as a function of the calculated voltage quantity.

8. The utility metering device according to claim 7, wherein the line-side voltage and the load-side voltage are out of phase in response to determining that there is a load-side voltage present and that V²_{line-load}h is above a first predefined threshold, and wherein the line-side voltage and the load-side voltage are in phase in response to determining that a load-side voltage is present and that V²_{line-load}h is below a second predefined threshold.

9. The utility metering device according to claim 7, wherein the application processing unit uses the determined phase relationship to determine if a utility service has been altered.

10. The utility metering device according to claim 9, further comprising an output that generates an alert in response to determining that the utility service has been altered.

11. An energy meter, comprising:
a service disconnect relay;
a load-side voltage detection circuit configured to detect load-side voltage;
a metering processing unit configured to receive the load-side voltage as an input from the load-side voltage detection circuit and measure magnitude of the detected load-side voltage; and
an application processing unit configured to receive the measured magnitude of the detected load-side voltage from the metering processing unit and control operation of the service disconnect relay as a function of the measured magnitude.

12. The energy meter according to claim 11, wherein the application processing unit is configured to maintain the service disconnect relay in an open state in response to determining that the measured magnitude is indicative of a presence of load-side voltage and close the service disconnect relay in response to determining the absence of load-side voltage.

13. The energy meter according to claim 11, further comprising a phase voltage measurement device that is configured to detect line-side voltage.

14. The energy meter according to claim 13, wherein the metering processing unit is further configured to receive the line-side voltage from the phase voltage measurement device for facilitating a determination of a phase relationship between the line-side voltage and the load-side voltage provided by the load-side detection circuit.

15. The energy meter according to claim 14, wherein the metering processing unit calculates a voltage quantity defined as: V_{line-load}²h=Σₖ₌₁^{N}(Vₗᵢₙₑ−V_{load})², where Vₗᵢₙₑ and V_{load} are line and load-side voltage samples, respectively, N is the number of samples in a momentary interval, h is hours and k is the index for the summation.

16. The energy meter according to claim 15, wherein the application processing unit determines the phase relationship between the line-side voltage and the load-side voltage provided by the load-side detection circuit as a function of the calculated voltage quantity, wherein the application processing unit uses the determined phase relationship to determine if a utility service has been altered.

17. The energy meter according to claim 16, wherein the line-side voltage and the load-side voltage are out of phase in response to determining that there is a load-side voltage present and that V²_{line-load}h is above a first predefined threshold, and wherein the line-side voltage and the load-side voltage are in phase in response to determining that a load-side voltage is present and that V²_{line-load}h is below a second predefined threshold.

18. A method for restoring an electric service, comprising:
detecting a load-side voltage;
inputting the load-side voltage to a metering processing unit;
measuring magnitude of the load-side voltage;
determining the presence of the load-side voltage as a function of the measured magnitude; and
restoring the electric service in response to determining that the measured magnitude is indicative of the absence of load-side voltage.

19. The method according to claim 18, further comprising prohibiting restoration of the electric service in response to determining that the measured magnitude is indicative of a presence of load-side voltage.

20. The method according to claim 18, further comprising:
detecting line-side voltage;
determining a phase relationship between line-side voltage and the load-side voltage;
determining if the electric service has been altered as a function of the phase relationship between the line-side voltage and the load-side voltage; and
generating an alert in response to determining that the electric service has been altered.
